(19) United States
(12) Patent Application Publication
(10) Pub. No.: US 2015/0288452 A1
(43) Pub. Date: Oct. 8, 2015

(54) COORDINATION OF PHYSICAL LAYER CHANNEL BONDING

(71) Applicants: Patrick STUPAR, (US); Andrea GARAVAGLIA, (US); Nicola VARANESE, San Diego, CA (US); Juan MONTOJO, San Diego, CA (US); Christian PIETSCH, (US); Honger NIE, (US); QUALCOMM INCORPORATED, San Diego, CA (US)

(72) Inventors: Patrick Stupar, Nuremberg (DE); Andrea Garavaglia, Nuremberg (DE); Nicola Varanese, Nuremberg (DE); Juan Montojo, Nuremberg (DE); Christian Pietsch, Nuremberg (DE); Honger Nie, Beijing (CN)

(21) Appl. No.: 14/427,967

(22) PCT Filed: Oct. 22, 2012
(86) PCT No.: PCT/CN2012/083299

§ 371 Date: Mar. 12, 2015

(51) Int. Cl. H04B 10/27; H04J 1/12; H04J 14/00

(52) U.S. Cl. CPC H04B 10/27; H04J 14/00; H04J 1/12

(57) ABSTRACT

A coax line terminal includes a first media access controller (MAC) corresponding to a first group of coax network units and a second MAC corresponding to a second group of coax network units. The coax line terminal also includes a first physical media entity (PME), coupled to the first MAC, to generate signals for transmission in a first frequency band, and a second PME, coupled to the first and second MACs, to generate signals for transmission in a second frequency band. The coax line terminal further includes a PME multiplexer to control access of the first and second MACs to the second PME.

### TECHNICAL FIELD

The present embodiments relate generally to communication systems, and specifically to communication systems that use multiple frequency bands.

### BACKGROUND OF RELATED ART

The Ethernet Passive Optical Networks (EPON) protocol may be extended over coaxial (coax) links in a cable plant. The EPON protocol as implemented over coax links is called EPoC. Implementing an EPoC network or similar network over a coax cable plant presents significant challenges. For example, multiple types of coax network units may be connected to the cable plant, with each type using a different set of frequency bands. Also, the frequency bands used for communication between a coax line terminal and coax network units of a given type may not be contiguous.

### BRIEF DESCRIPTION OF THE DRAWINGS

The present embodiments are illustrated by way of example and are not intended to be limited by the figures of the accompanying drawings.

FIG. 1A is a block diagram of a coaxial network in accordance with some embodiments.

FIG. 1B is a block diagram of a network that includes both optical links and coax links in accordance with some embodiments.

FIGS. 2A and 2B illustrate frequency spectra in accordance with some embodiments.

FIGS. 3A and 3B are block diagrams of coax line terminals in accordance with some embodiments.

FIGS. 4A and 4B are block diagrams of coax network units in accordance with some embodiments.

FIG. 5 is a flowchart illustrating a method of operating a coax line terminal in accordance with some embodiments.

Like reference numerals refer to corresponding parts throughout the drawings and specification.

### DETAILED DESCRIPTION

Embodiments are disclosed in which multiple frequency bands are aggregated in the physical layer using digital processing.

In some embodiments, a coax line terminal includes a first media access controller (MAC) corresponding to a first group of coax network units and a second MAC corresponding to a second group of coax network units. The coax line terminal also includes a first physical media entity (PME), coupled to the first MAC, to generate signals for transmission in a first frequency band, and a second PME, coupled to the first and second MACs, to generate signals for transmission in a second frequency band. The coax line terminal further includes a PME multiplexer to control access of the first and second MACs to the second PME.

In some embodiments, a method of operating a coax line terminal includes providing data from a first media access controller (MAC) to a first physical media entity (PME) and multiplexing data from the first MAC and from a second MAC into a second PME. The first MAC corresponds to a first group of coax network units and the second MAC corresponds to a second group of coax network units. The first PME generates signals for transmission in a first frequency band and the second PME generates signals for transmission in a second frequency band.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

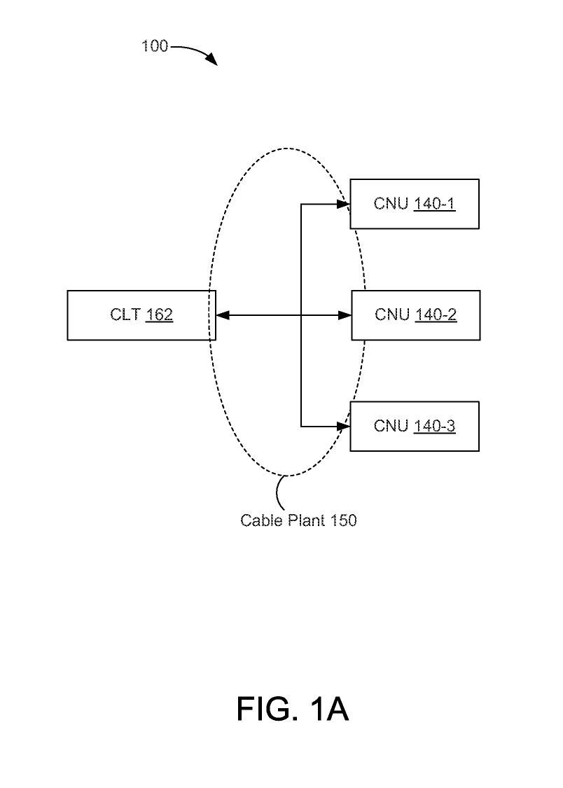

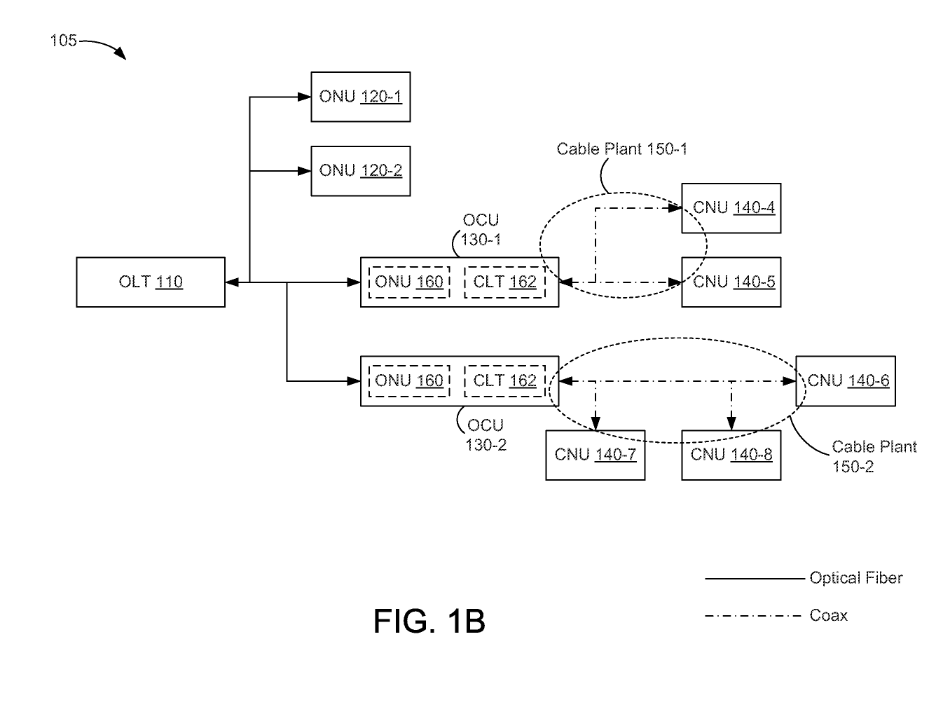

FIG. 1A is a block diagram of a coax network 100 (e.g., an EPoC network) in accordance with some embodiments. The network 100 includes a coax line terminal (CLT) 162(also referred to as a coax link terminal) coupled to a plurality of coax network units (CNUs) 140-1, 140-2, and 140-3 via coax links. A respective coax link may be a passive coax cable, or may also include one or more amplifiers and/or equalizers. The coax links compose a cable plant 150. In some embodiments, the CLT 162 is located at the head end of the cable plant150 and the CNUs 140 are located at the premises of respective users.

The CLT 162 transmits downstream signals to the CNUs 140-1, 140-2, and 140-3 and receives upstream signals from the CNUs 140-1, 140-2, and 140-3. In some embodiments, each CNU 140 receives every packet transmitted by the CLT 162 and discards packets that are not addressed to it. The CNUs 140-1, 140-2, and 140-3 transmit upstream signals at scheduled times (e.g., in scheduled time slots) specified by the CLT 162. For example, the CLT 162 transmits control messages (e.g., GATE messages) to the CNUs 140-1, 140-2, and 140-3 specifying respective future times at which respective CNUs 140 may transmit upstream signals.

In some embodiments, the CLT 162 is part of an optical-coax unit (OCU) 130 that is also coupled to an optical line terminal (OLT) 110, as shown in FIG. 1B. FIG. 1B is a block diagram of a network 105 that includes both optical links and coax links in accordance with some embodiments. The network 105 includes an optical line terminal (OLT) 110 (also referred to as an optical link terminal) coupled to a plurality of optical network units (ONUs) 120-1 and 120-2 via respective optical fiber links. The OLT 110 also is coupled to a plurality of optical-coax units (OCUs) 130-1 and 130-2 via respective optical fiber links. (OCUs are sometimes also referred to as media converters or coax media converters (CMCs)).

In some embodiments, each OCU 130-1 and 130-2 includes an ONU 160 coupled with a CLT 162. The ONU 160 receives downstream packet transmissions from the OLT 110 and provides them to the CLT 162, which forwards the packets to the CNUs 140 on its cable plant 150. In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1B, the first OCU 130-1 communicates with CNUs 140-4 and 140-5, and the second OCU 130-2 communicates with CNUs 140-6, 140-7, and 140-8. The coax links coupling the first OCU 130-1 with CNUs 140-4 and 140-5 compose a first cable plant 150-1. The coax links coupling the second OCU 130-2 with CNUs 140-6 through 140-8 compose a second cable plant 150-2. A respective coax link may be a passive coax cable, or alternately may include one or more amplifiers and/or equalizers. In some embodiments, the OLT 110, ONUs 120-1 and 120-2, and optical portions of the OCUs 130-1 and 130-2 are implemented in accordance with the Ethernet Passive Optical Network (EPON) protocol.

In some embodiments, the OLT 110 is located at a network operator's headend, the ONUs 120 and CNUs 140 are located at the premises of respective users, and the OCUs 130 are located at the headend of their respective cable plants 150.

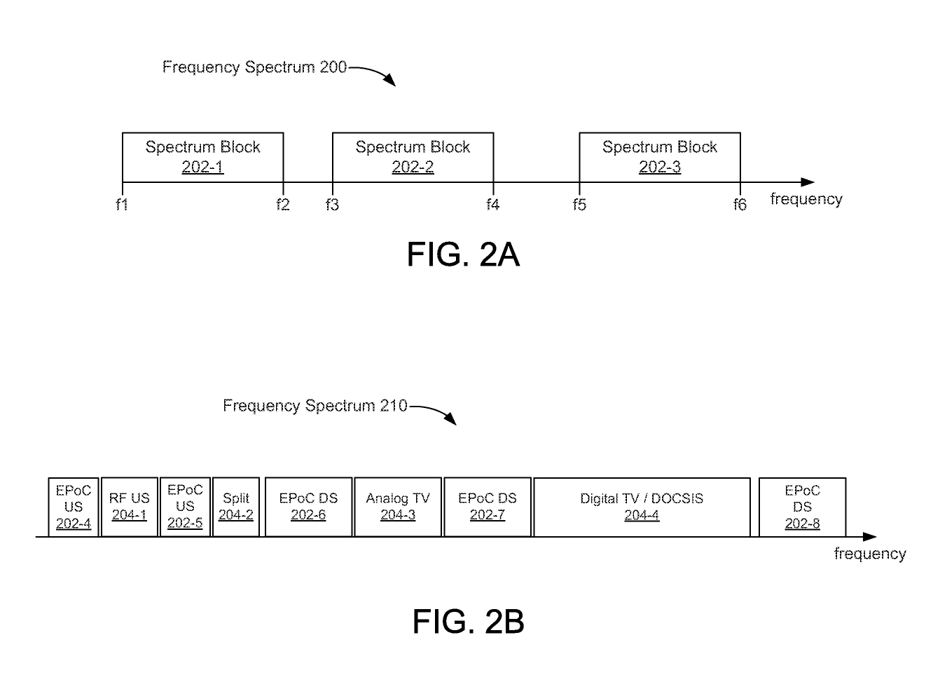

A CLT 162 may communicate with CNUs 140 on its cable plant 150 using multiple blocks of frequency spectrum. FIG. 2A illustrates a frequency spectrum 200 that includes multiple spectrum blocks 202-1, 202-2, and 202-3 in accordance with some embodiments. The blocks 202-1, 202-2, and 202-3 may also be referred to as frequency chunks or frequency bands. The block 202-1 extends from a lower frequency f1 to an upper frequency f2. The block 202-2 extends from a lower frequency f3 to an upper frequency f4. The block 202-3 extends from a lower frequency f5 to an upper frequency f6. The blocks 202-1, 202-2, and 202-3 thus are non-contiguous: the blocks 202-1 and 202-2 are separated by a frequency band between f2 and f3 and the blocks 202-2 and 202-3 are separated by a frequency band between f4 and f5. Despite the blocks 202-1, 202-2, and 202-3 being non-contiguous, the CLT 162 may aggregate two or more blocks (e.g., all of the blocks 202-1, 202-2, and 202-3, or a subset thereof) into a single logical channel used to transmit packets to and/or receive packets from CNUs 140. This aggregation is referred to as channel bonding.

Furthermore, different CNUs 140 to which a CLT 162 is coupled may have different transmission and reception capabilities. The CNUs 140 may include a first group of CNUs 140 (e.g., of a first type or first generation) that can communicate using a first set of spectrum blocks 202 and a second group of CNUs 140 (e.g., of a second type or second generation) that can communicate using a second set of spectrum blocks 202. For example, the CNUs 140-1 and 140-2 (FIG. 1A) may be included in a first group and the CNU 140-3 (FIG. 1A) may be included in a second group; each group may include other CNUs not shown in FIG. 1A for simplicity. The first and second sets of spectrum blocks 202 may overlap. In one example, the first group of CNUs 140 can communicate with the CLT 162 using all three blocks 202-1, 202-2, and 202-3, while the second group of CNUs 140 can communicate with the CLT 162 using only a subset of the three blocks 202-1, 202-2, and 202-3. In another example, the first group of CNUs 140 can communicate with the CLT 162 using the blocks 202-1 and 202-2 and the second group of CNUs 140 can communicate using the blocks 202-2 and 202-3. Other examples are possible. The CLT 162 is able to aggregate the first set of blocks 202 into a first logical channel and the second set of blocks 202 into a second logical channel.

FIG. 2B illustrates another frequency spectrum 210 in accordance with some embodiments. The spectrum 210 includes spectrum blocks 202-4 through 202-8 that a CLT 162 may use for communication with CNUs 140 based on EPoC or a similar protocol. The blocks 202-4 through 202-8 are non-contiguous: they are separated by other blocks 204-1 through 204-4 that may be used for other services (e.g., legacy services) or may be unused. For example, the block 204-1 is used for radio-frequency (RF) upstream (US) transmissions, the block 204-2 is a split block that may act as a guard band, the block 204-3 is used for analog television, and the block 204-4 is used for digital television and for communications using the Data Over Cable Service Interface Specification (DOCSIS), a legacy protocol.

The frequency spectrum 210 illustrates frequency-division duplexing (FDD). Blocks 202-4 and 202-5 are dedicated for upstream (US) EPoC transmissions from CNUs 140 to a CLT 162, while blocks 202-6, 202-7, and 202-8 are dedicated for downstream (DS) EPoC transmissions from the CLT 162 to CNUs 140. (While the frequency spectrum 210 illustrates FDD, physical-layer channel bonding as described herein may also be performed for time-division duplexing (TDD), in which spectrum blocks 202 are used for both upstream and downstream transmissions during respective time slots.)Furthermore, as discussed with regard to FIG. 2A, different CNUs 140 may use different blocks 202. For example, a first group of CNUs 140 may be capable of receiving downstream transmissions in all three EPoC DS blocks 202-6, 202-7, and 202-8, while a second group of CNUs 140 may be capable of receiving downstream transmissions in the EPoC DS blocks 202-6 and 202-7 but not the EPoC DS block 202-8. In this example, the CLT 162 is able to aggregate all three EPoC DS blocks 202-6, 202-7, and 202-8 into a first logical channel for communications with the first group of CNUs 140 and is also able to aggregate the EPoC DS blocks 202-6 and 202-7 into a second logical channel for communications with the second group of CNUs 140. The CLT 162 also performs aggregation for upstream transmissions, for example by aggregating the EPoC US blocks 202-4 and 202-5 into a single logical channel.

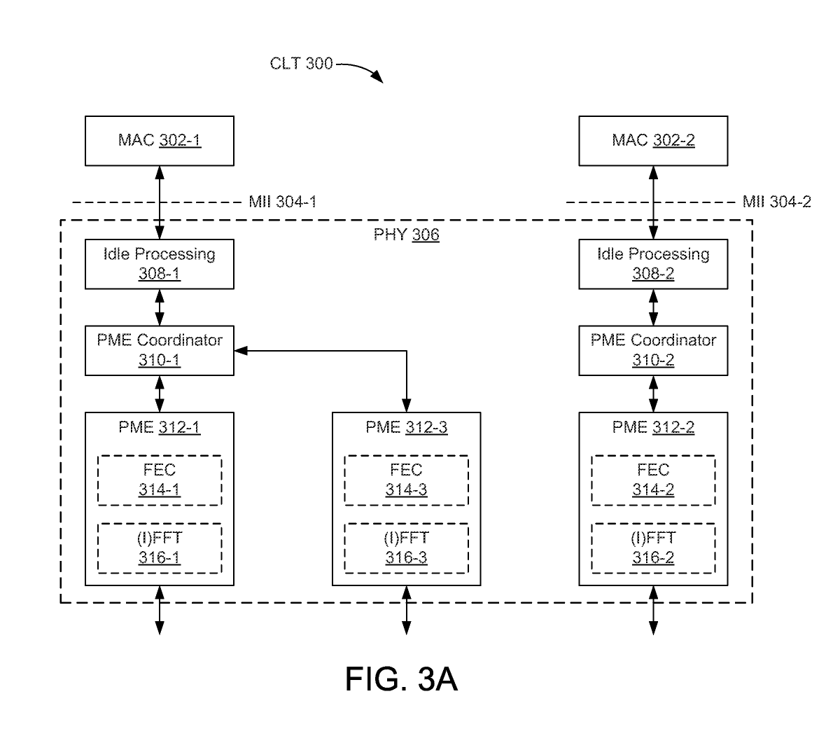

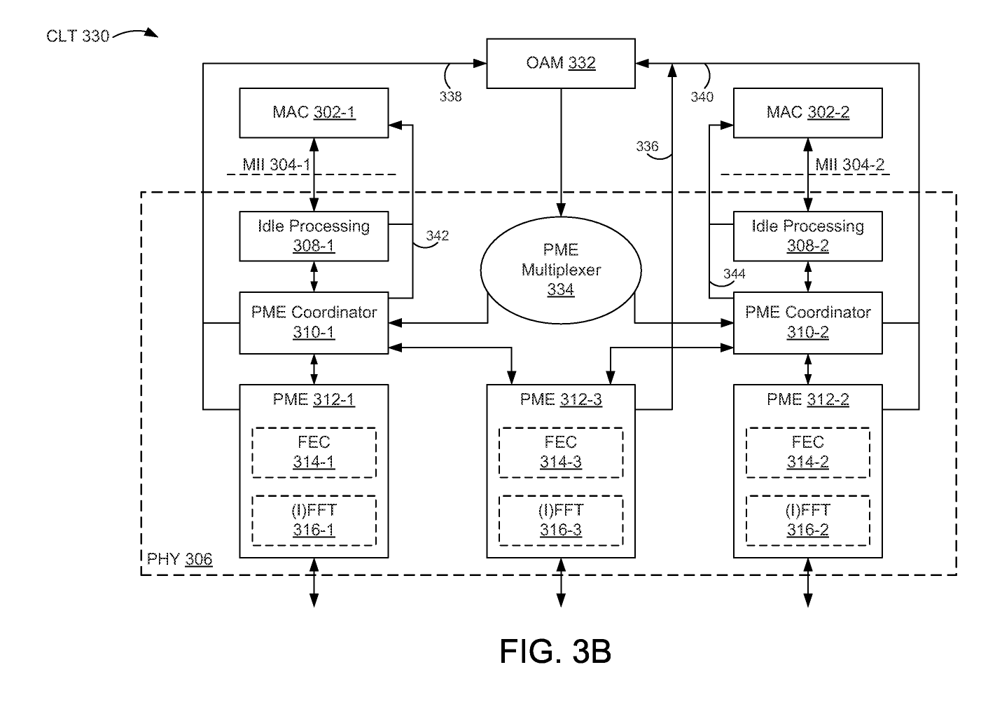

FIG. 3A is a block diagram of a CLT 300, which is an example of a CLT 162 (FIGS. 1A-1B) in accordance with some embodiments. The CLT 300 includes a separate media access controller (MAC) 302 (also referred to as a MAC block 302) for each group (e.g., each type or generation) of CNU 140 to which the CLT 300 may be coupled. For example, the CLT 300 includes a first MAC 302-1 corresponding to a first group of CNUs 140 and a second MAC 302-2 corresponding to a second group of CNUs 140. A first media-independent interface (MII) 304-1 couples the first MAC 302-1 to a physical layer device (PHY) 306, and a second MII 304-2 couples the second MAC 302-2 to the PHY 306. In some embodiments, the MIIs 304-1 and 304-2 are XGMII interfaces. (As used herein, the term media-independent interface or MII refers to the genus of such interfaces, which includes for example XGMII, and does not refer only to the specific species of MII that is also known as MII).

The PHY 306 includes a separate physical media entity (PME) 312 for each spectrum block (i.e., frequency band) 202. For example, the PHY 306 includes a first PME 312-1 to generate signals for transmission (and/or to process received signals) in the first spectrum block 202-1 (FIG. 2A), a second PME 312-2 to generate signals for transmission (and/or to process received signals) in the second spectrum block 202-2 (FIG. 2A), and a third PME 312-3 to generate signals for transmission (and/or to process received signals) in the third spectrum block 202-3 (FIG. 2A). Each PME 312 performs the physical layer operations of baseband processing, digital-to-analog (and/or analog-to-digital) conversion, and/or analog processing for signals transmitted and/or received in the corresponding spectrum block 202. For example, the first PME 312-1 includes a forward-error correction (FEC) block 314-1 to perform FEC coding and a block 316-1 to perform inverse fast-Fourier transform (IFFT) processing (for signal transmission) and/or fast-Fourier transform (FFT) processing (for signal reception). Similarly, the second PME 312-2 includes an FEC block 314-2 and an IFFT/FFT block 316-2, and the third PME 312-3 includes an FEC block 314-3 and an IFFT/FFT block 316-3.

In the example of the CLT 300, the first group of CNUs 140 communicates using the spectrum blocks 202-1 and 202-3 (FIG. 2A), and the second group of CNUs 140 communicates using the spectrum block 202-2. The PMEs 312-1, 312-2, and 312-3 respectively process signals in the blocks 202-1, 202-2, and 202-3. Because the first MAC 302-1 is for the first group of CNUs 140, it thus is coupled to the first PME 312-1 and the third PME 312-3. Because the second MAC 302-2 is for the second group of CNUs 140, it thus is coupled to the second PME 312-2.

Coupled between the MAC 302-1 and the PMEs 312-1 and 312-3 are an idle character processing block 308-1 and a PME coordinator 310-1. Similarly, an idle character processing block 308-2 and PME coordinator 310-2 are coupled between the MAC 302-2 and PME 312-2. For transmission, the idle character processing blocks 308-1 and 308-2 remove idle characters in bitstreams received from the MACs 302-1 and 302-2 over the MIIs 304-1 and 304-2. For reception, the idle character processing blocks 308-1 and 308-2 insert idle characters into bitstreams transmitted to the MACs 302-1 and 302-2 across the MIIs 304-1 and 304-2. The idle characters are used to maintain a constant rate for the bitstreams crossing the MIIs 304-1 and 304-2. The idle character processing blocks 308-1 and 308-2 are optional and can be replaced by other spectrum-independent processing.

For transmission, the PME coordinator 310-1 provides data in packets from the MAC 302-1 to the PMEs 312-1 and 312-3, and the PME coordinator 310-2 provides data in packets from the MAC 302-2 to the PME 312-3. For example, the PME coordinator 310-1 provides a first stream to the PME 312-1 and a second stream to the PME 312-3, and the PME coordinator 310-2 provides a stream to the PME 312-2. The PME coordinator 310-1 thus implements channel bonding.

In the example of the CLT 300, the spectrum blocks 202 used for communications with respective groups of CNUs 140 do not overlap. In other examples, there is overlap in the spectrum blocks 202 used for communications with respective groups of CNUs 140. As a result, multiple MACs 302 may be coupled to a single PME 312.

FIG. 3B illustrates a CLT 330 (e.g., a CLT 162, FIGS. 1A-1B) configured to be coupled to a first group of CNUs 140 that use spectrum blocks 202-1 and 202-3 (FIG. 2A) and a second group of CNUs 140 that use spectrum blocks 202-2 and 202-3 (FIG. 2A) in accordance with some embodiments. Use of the spectrum block 202-2 thus overlaps between the first and second groups of CNUs 140. The MAC 302-1 is used for communicating with the first group of CNUs 140 and the MAC 302-2 is used for communicating with the second group of CNUs 140. As discussed, the PMEs 312-1, 312-2, and 312-3 correspond respectively to the spectrum blocks 202-1, 202-2, and 202-3. Accordingly, the MAC 302-1 is coupled through the idle character processing block 308-1 and PME coordinator 310-1 to the PMEs 312-1 and 312-3, and the MAC 302-2 is coupled through the idle character processing block 308-2 and PME coordinator 310-2 to the PMEs 312-2 and 312-3. The PME coordinator 310-1 provides packets from the MAC 302-1 to the PME 312-1 in a first stream and to the PME 312-3 in a second stream, and the PME coordinator 310-2 provides packets from the MAC 302-2 to the PME 312-2 in a third stream and to the PME 312-3 in a fourth stream.

Because the MACs 302-1 and 302-2 are both coupled to the PME 312-3, access to the PME 312-3 by the MACs 302-1 and 302-2 is controlled to prevent overflow. A PME multiplexer 334 provides control signals to the PME coordinators 310-1 and 310-2 to regulate the supply of data from the PME coordinators 310-1 and 310-2 to the PME 312-3, and thus to control access to the PME 312-3. While the PME multiplexer 334 is shown as a distinct functional block in FIG. 3B, the PME multiplexer 334 may be distributed across multiple functional blocks and/or included in other functional blocks. For example, the PME multiplexer 334 may be distributed across the PME coordinators 310-1 and 310-2, such that a first portion of the PME multiplexer 334 is situated in the PME coordinator 310-1 and a second portion is situated in the PME coordinator 310-2. In some embodiments, multiplexing of data into the PME 312-3 is performed in the time domain: the PME multiplexer 334 allocates respective time slots to the PME coordinators 310-1 and 310-2 for accessing the PME 312-3. In other embodiments, this multiplexing is performed in the frequency domain: the PME multiplexer 334 allocates a first portion of the spectrum block 202-3 for data from the PME coordinator 310-1 and a second portion of the spectrum block 202-3 for data from the PME coordinator 310-2. In still other embodiments, the multiplexing is performed using code-division multiple access (CDMA), in which packets from the PME coordinators 310-1 and 310-2 are encoded using orthogonal codes. These are merely examples of multiplexing schemes that the PME multiplexer 334 may use.

The PME multiplexer 334 generates the control signals provided to the PME coordinators 310-1 and 310-2 based on input signals received from an operations, administration, and management (OAM) sub-layer 332 (or more generally, an administrative sub-layer). (Alternatively, the OAM sublayer 332 generates the control signals provided to the PME coordinators 310-1 and 310-2, for example when the PME multiplexer 334 is distributed between the PME coordinators 310-1 and 310-2.) The OAM sublayer 332 generates the input signals based on feedback received from the PMEs 312-1, 312-2, and/or 312-3. The PME 312-3 reports an achievable data rate (e.g., its achievable throughput) to the OAM sub-layer 332 through a feedback path 336. In some embodiments, the PMEs 312-1 and 312-2 also report their achievable data rates to the OAM sub-layer 332 through respective feedback paths 338 and 340. The PME coordinators 310-1 and 310-2 may also report their data rates to the OAM sub-layer 332 through the respective feedback paths 338 and 340.

The MACs 302-1 and 302-2 adapt packet transmissions based on respective feedback from the idle character processing blocks 308-1 and 308-2 and/or the PME coordinators 310-1 and 310-2. The idle character processing block 308-1 and PME coordinator 310-1 report their effective data rates to the MAC 302-1 through a feedback path 342. Based on this feedback, the MAC 302-1 adjusts the rate of packet transmission. The MAC 302-1 adjusts the insertion of idle characters into the bitstream that the MAC 302-1 transmits across the MII 304-1 to maintain a constant bitstream rate despite the changed rate of packet transmission. The MAC 302-2 operates similarly, based on the effective data rates of the idle character processing block 308-2 and PME coordinator 310-1 as provided through a feedback path 344.

FIG. 3B shows each MAC 302 coupled to two PMEs 312, with one PME 312-3 being shared between the MACs 302-1 and 302-2. In other examples, three or more PMEs 312 may be coupled to a respective MAC 302 through a respective PME coordinator 310. Also, two or more PMEs 312 may be shared between MACs 302, with a PME multiplexer 334 controlling access to each of the shared PMEs 312. Furthermore, a CLT 162 may include three or more MACs 302, each corresponding to a respective group of CNUs 140.

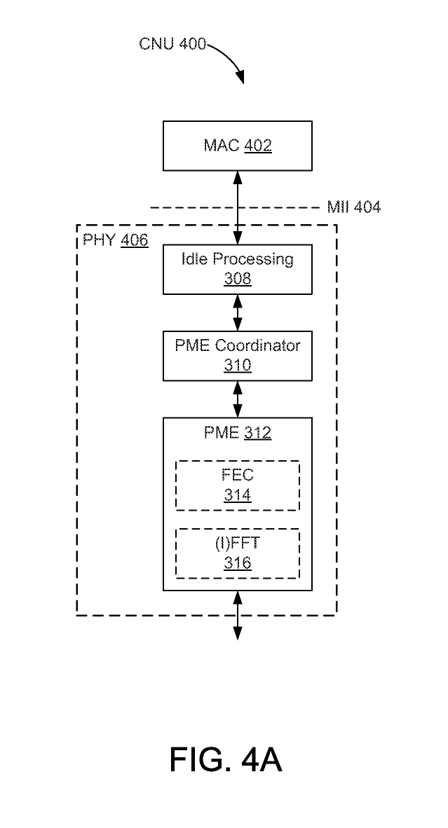

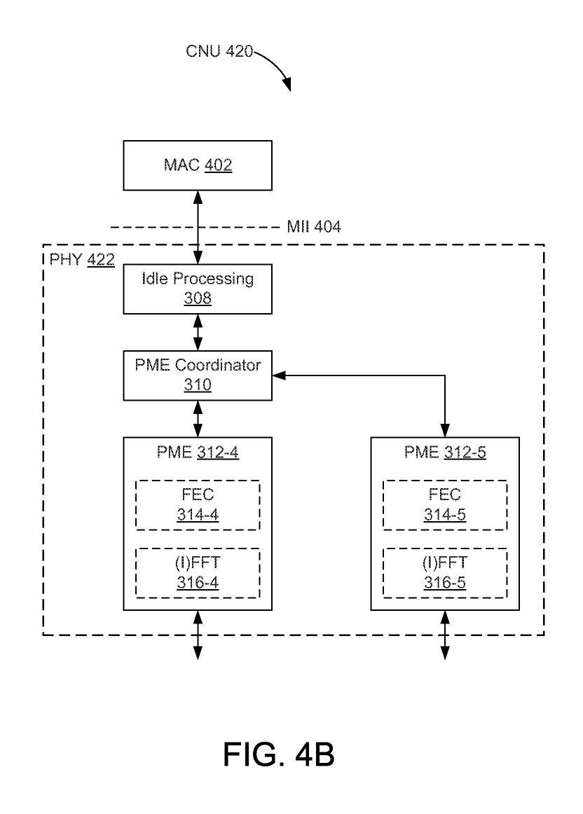

FIG. 4A is a block diagram of a CNU 400 in accordance with some embodiments. The CNU 400 is an example of a CNU 140 (FIGS. 1A-1B) and is configured to communicate in a single spectrum block (i.e., frequency band) 202 (e.g., one of the spectrum blocks 202-1 through 202-3, FIG. 2A). The CNU 400 includes a single PME 312 for transmitting and/or receiving signals in the single spectrum block 202. The PME 312 is situated in a PHY 406 that is coupled to a MAC 402 through an MII 404 (e.g., an XGMII interface). The PHY 406 includes a PME coordinator 310 and idle character processing block 308 coupled between the PME 312 and the MII 404. The idle character processing block 308, PME coordinator 310, and PME 312 function as described with regard to FIGS. 3A and 3B.

FIG. 4B is a block diagram of a CNU 420 in accordance with some embodiments. The CNU 420 is an example of a CNU 140 (FIGS. 1A-1B) and is configured to communicate in two spectrum blocks (i.e., frequency bands) 202 (e.g., two of the spectrum blocks 202-1 through 202-3, FIG. 2A). The CNU 420 includes a first PME 312-4, including an FEC block 314-4 and IFFT/FFT block 316-4, for transmitting and/or receiving signals in a first spectrum block 202 and a second PME 312-5, including an FEC block 314-5 and IFFT/FFT BLOCK 316-5, for transmitting and/or receiving signals in a second spectrum block 202. The PMEs 312-4 and 312-5 are situated in a PHY 422 that is coupled to a MAC 402 through an MII 404 (e.g., an XGMII interface). The PHY 422 includes a PME coordinator 310 and idle character processing block 308 coupled between the PMEs 312-4 and 312-5 and the MII 404. The idle character processing block 308, PME coordinator 310, and PMEs 312-4 and 312-5 function as described with regard to FIGS. 3A and 3B. For example, the PME coordinator 310 provides packets from the MAC 402 to the PMEs 312-4 and 312-5 (e.g., by providing a first stream to the PME 312-4 and a second stream to the PME 312-5). While the CNU 420 is shown with two PMEs 312-4 and 312-5, it may include three or more PMEs 312 coupled to the MAC 402.

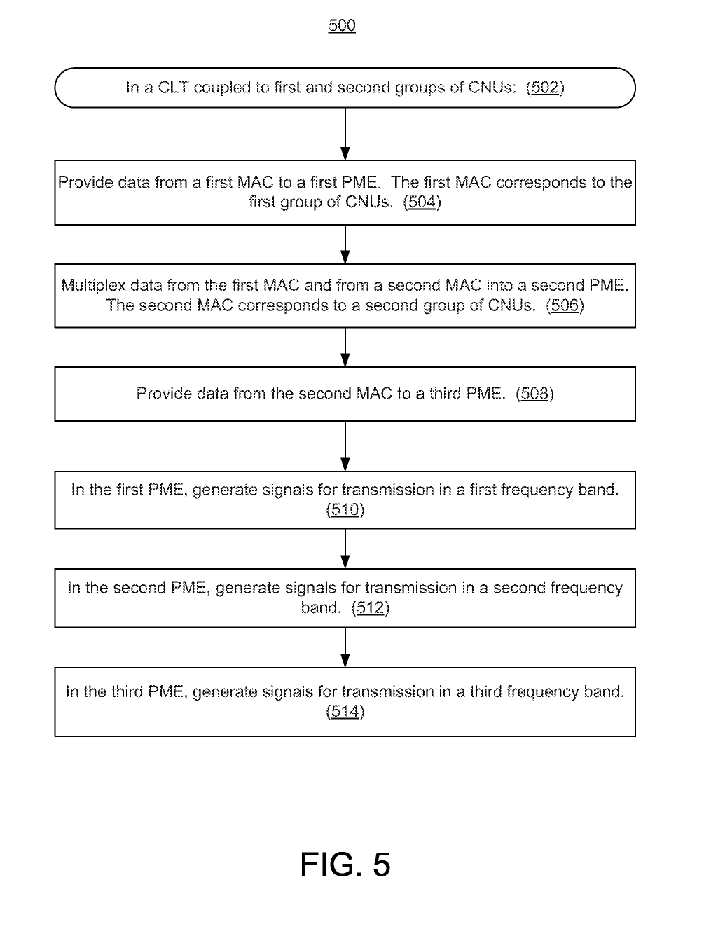

FIG. 5 is a flowchart illustrating a method 500 of operating a CLT 162 (FIGS. 1A-1B) (e.g., a CLT 330, FIG. 3B)in accordance with some embodiments. The CLT 162 is coupled (502) to first and second groups of CNUs 140 (FIGS. 1A-1B).

In the method 500, data is provided (504) from a first MAC (e.g., MAC 302-1, FIG. 3B) to a first PME (e.g., PME 312-1, FIG. 3B). The first MAC corresponds to the first group of CNUs 140.

Data is multiplexed (506) from the first MAC and from a second MAC (e.g., MAC 302-2, FIG. 3B) into a second PME (e.g., PME 312-3, FIG. 3B). The second MAC corresponds to a second group of CNUs 140.

In some embodiments, the multiplexing 506 includes providing control signals (e.g., from a PME multiplexer 334, FIG. 3B) to a first PME coordinator (e.g., PME coordinator 310-1, FIG. 3B) coupled to the first MAC and a second PME coordinator (e.g., PME coordinator 310-2, FIG. 3B) coupled to the second MAC, and further includes providing data from the first and second PME coordinators to the second PME in accordance with the control signals. Feedback is generated indicating a data rate of the second PME and the control signals are generated in accordance with the feedback. For example, the PME 312-3 (FIG. 3B) provides feedback to the OAM sublayer 332 through the feedback path 336, and the OAM sublayer 332 generates input signals that controls the PME multiplexer 334, based at least in part on the feedback.

In some embodiments, data is provided (508) from the second MAC to a third PME (e.g., PME 312-2, FIG. 3B).

In some embodiments, feedback is provided from the first PME coordinator to the first MAC (e.g., through feedback path 342, FIG. 3B) indicating a data rate of the first PME coordinator and from the second PME coordinator to the second MAC (e.g., through feedback path 344, FIG. 3B) indicating a data rate of the second PME coordinator. The first MAC adapts packet transmissions (e.g., adjusts the rate of packet transmission) in accordance with the feedback from the first PME controller and the second MAC adapts packet transmissions in accordance with the feedback from the second PME controller. The feedback provided to the first and second MACs by the PME coordinators can be calculated based on the input provided by the PMEs and the PME multiplexer.

Signals are generated (510) in the first PME for transmission in a first frequency band. Signals are generated (512) in the second PME for transmission in a second frequency band. In some embodiments, signals are generated (514) in the third PME for transmission in a third frequency band.

The method 500 thus performs physical-layer aggregation of frequency bands in the digital domain. While the method 500 includes a number of operations that appear to occur in a specific order, it should be apparent that the method 500 can include more or fewer operations, which can be executed serially or in parallel. An order of two or more operations may be changed and two or more operations may be combined into a single operation. For example, all of the operations of the method 500 may be performed in parallel in an on-going basis.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A coax line terminal, comprising:
a first media access controller (MAC) corresponding to a first group of coax network units;
a second MAC corresponding to a second group of coax network units;
a first physical media entity (PME), coupled to the first MAC, to generate signals for transmission in a first frequency band;
a second PME, coupled to the first and second MACs, to generate signals for transmission in a second frequency band; and
a PME multiplexer to control access of the first and second MACs to the second PME.

2. The coax line terminal of claim 1, comprising:
a first PME coordinator, coupled between the first MAC and the first and second PMEs, to provide data from the first MAC to the first and second PMEs;
a second PME coordinator, coupled between the second MAC and the second PME, to provide data from the second MAC to the second PME.

3. The coax line terminal of claim 2, further comprising a third PME, coupled to the second PME coordinator, to generate signals for transmission in a third frequency band, wherein the second PME coordinator is to provide data from the second MAC to the third PME.

4. The coax line terminal of claim 2, wherein the PME multiplexer comprises a first portion situated in the first PME coordinator and a second portion situated in the second PME coordinator.

5. The coax line terminal of claim 2, wherein the first and second PME coordinators are to provide data to the second PME in accordance with control signals from the multiplexer.

6. The coax line terminal of claim 2, further comprising an administrative sublayer to provide input signals to the PME multiplexer, wherein the PME multiplexer is to control access to the second PME in accordance with the input signals.

7. The coax line terminal of claim 6, wherein the administrative sublayer comprises an Operations, Administration, and Maintenance (OAM) sublayer.

8. The coax line terminal of claim 6, further comprising a feedback path from the second PME to the administrative sublayer to communicate to the administrative sublayer a data rate of the second PME, wherein the administrative sublayer is to generate the input signals based at least in part on the data rate of the second PME.

9. The coax line terminal of claim 8, further comprising:
a feedback path from the first PME to the administrative sublayer to communicate to the administrative sublayer a data rate of the first PME;
wherein the administrative sublayer is to generate the input signals based at least in part on the data rate of the first PME.

10. The coax line terminal of claim 2, further comprising:
a feedback path from the first PME coordinator to the first MAC to communicate to the first MAC a data rate of the first PME coordinator; and
a feedback path from the second PME coordinator to the second MAC to communicate to the second MAC a data rate of the second PME coordinator;
wherein the first and second MACs are to adapt packet transmissions to the respective data rates of the first and second PME coordinators.

11. The coax line terminal of claim 10, further comprising:
a first idle character processing block, coupled between the first MAC and the first PME coordinator, to receive a first bitstream from the first MAC at a constant rate and to remove idle characters from the first bitstream; and
a second idle character processing block, coupled between the second MAC and the second PME coordinator, to receive a second bitstream from the second MAC at the constant rate and to remove idle characters from the first bitstream;
wherein the first and second MACs are to insert variable numbers of idle characters into the first and second bitstreams to adapt the packet transmissions to the respective data rates of the first and second PME coordinators.

12. The coax line terminal of claim 2, wherein:
the first PME coordinator is to provide a first stream to the first PME and a second stream to the second PME; and
the second PME coordinator is to provide a third stream to the second PME.

13. The coax line terminal of claim 1, wherein the PME multiplexer is to control access to the second PME in accordance with time-division duplexing of the second frequency band.

14. The coax line terminal of claim 1, wherein the PME multiplexer is to control access to the second PME in accordance with frequency-division duplexing of the second frequency band.

15. The coax line terminal of claim 1, wherein the PME multiplexer is to control access to the second PME in accordance with a code-division multiple access protocol.

16. A method of operating a coax line terminal, comprising:
providing data from a first media access controller (MAC) to a first physical media entity (PME), wherein the first MAC corresponds to a first group of coax network units;
multiplexing data from the first MAC and from a second MAC into a second PME, wherein the second MAC corresponds to a second group of coax network units;
in the first PME, generating signals for transmission in a first frequency band; and
in the second PME, generating signals for transmission in a second frequency band.

17. The method of claim 16, wherein the multiplexing comprises:
providing control signals to a first PME coordinator coupled to the first MAC and a second PME coordinator coupled to the second MAC; and
providing data from the first and second PME coordinators to the second PME in accordance with the control signals.

18. The method of claim 17, further comprising:
generating feedback indicating a data rate of the second PME; and
generating the control signals in accordance with the feedback.

19. The method of claim 17, further comprising:
providing feedback from the first PME coordinator to the first MAC indicating a data rate of the first PME coordinator;
providing feedback from the second PME coordinator to the second MAC indicating a data rate of the second PME coordinator;
adapting packet transmissions by the first MAC in accordance with the feedback from the first PME controller; and
adapting packet transmissions by the second MAC in accordance with the feedback from the second PME controller.

20. The method of claim 16, further comprising:
providing data from the second MAC to a third PME; and
in the third PME, generating signals for transmission in a third frequency band.

21. A coax line terminal, comprising:
means for providing data from a first media access controller (MAC) to a first physical media entity (PME) and a second PME;
means for providing data from a second MAC to the second PME; and
means for controlling access of the first and second MACs to the second PME.
